(19) United States
(12) Patent Application Publication
(10) Pub. No.: US 2006/0197524 A1
(43) Pub. Date: Sep. 7, 2006

(54) Magnetic resonance imaging method

(76) Inventor: Gabriele Marianne Beck, Eindhoven (NL)

Correspondence Address: PHILIPS INTELLECTUAL PROPERTY & STANDARDS, 595 MINER ROAD, CLEVELAND, OH, 44143, US

(21) Appl. No.: 10/547,093

(22) PCT Filed: Feb. 25, 2004
(86) PCT No.: PCT/IB04/50149

§ 371 Date: Aug. 26, 2005

(30) Foreign Application Priority Data
Mar. 3, 2003 (EP) 03100523.4

(51) Int. Cl. G01V 3/00

(52) U.S. Cl. 324/307; 324/309

(57) ABSTRACT

A novel magnetic resonance imaging method is described, for two-dimensional or three-dimensional imaging of an examination zone, in which k-space is segmented in several parts and is scanned at predetermined sampling positions. Magnetic resonance signals of a first part over k-space and magnetic resonance signals of a different second part over k-space are acquired. Data of the second part are completed with data of the first part in order to obtain a full image of the scanned object. For a given profile sharing factor a group of profiles is shared with previous dynamic scans in the second part of kspace. In a third part a group of profiles is shared with subsequent dynamic scans and in the first part one or more groups are not shared in further scans.

The invention relates to a magnetic resonance imaging method for two-dimensional or three-dimensional imaging of an examination zone, in which k-space is scanned at predetermined sampling positions, whereas magnetic resonance signals of a first data set over k-space and magnetic resonance signals of subsequent reduced data sets over part of k-space are acquired, and data of the subsequent reduced data sets are completed with data of the first data set in order to obtain a full image of the scanned object.

The invention also relates to an MR apparatus and a computer program product for carrying out such a method.

It is generally known to diminish the acquisition time for a set of data by sharing the acquisition data of previous sets or scans, which is called in general profile sharing. There are different known methods of profile sharing like the so called “keyhole method”, wherein the central part of the k-space will be acquired more often because dynamics for instance for cardiac MR scans occur more in the central k-profiles. Profile sharing as such is also known under the names GES, FAST CARD, TRICKS etc. The basic principle of these acquisition schemes is that the k-space being divided in segments which are acquired with different frequencies, which acquisition segments will be combined with more often repeated central k-space profiles. In this manner the resolution in time between subsequent images can be improved.

The above mentioned acquisition schemes do have several drawbacks in that these profile sharing scans will only give a satisfactory result for dynamic scans. On the other hand the image data in the outer k-space will be defined once and for all, which may influence the resolution negatively.

It is an object of the present invention to improve the acquisition scheme in profile sharing that faster imaging in magnetic resonance will be available whereas problems like fold-over artefacts and/or ghosting and too low resolution will be suppressed to a great extent. A further object of the present invention is to provide a magnetic resonance apparatus and a computer program product designed for faster imaging while suppressing the forming of fold-over artefacts and/or ghosting.

The first object of the invention is accomplished by a magnetic resonance imaging method as defined in claim 1. The further objects of this invention are accomplished by a magnetic resonance apparatus according to claim 5 and by a computer program product according to claim 6.

These and other advantages of the invention are disclosed in the dependent claims and in the following description in which an exemplified embodiment of the invention is described with respect to the accompanying drawings. Therein shows:

FIG. 1 an acquisition scheme in k-space according to the present invention,

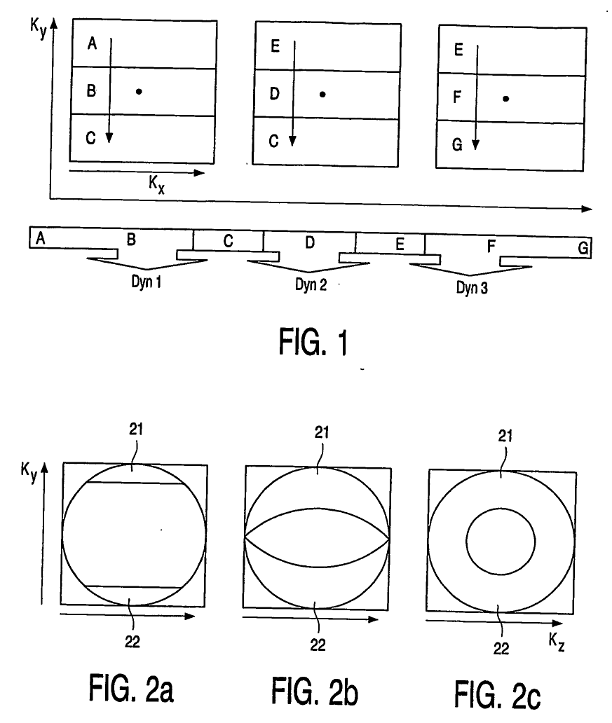

FIG. 2 another acquisition scheme in k-space for a 3D dynamic scan, and

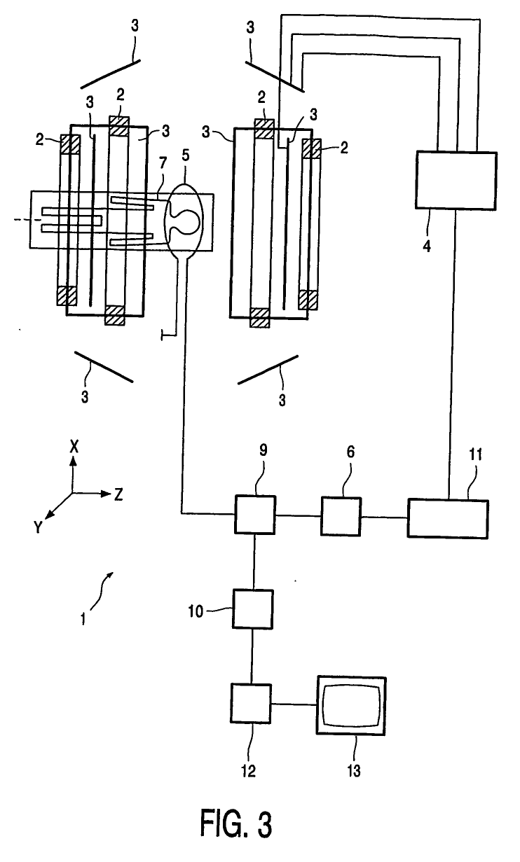

FIG. 3 diagrammatically a magnetic resonance imaging system in which the present invention is used

The acquisition technique provided by the present invention is based on a compression of dynamic MR imaging by the use of profile sharing and a specific profile order technique. This technique comprises several steps:

1. For a given sequence the time resolution as an input parameter can be reduced within predetermined limits which are adapted to a given profile sharing factor.

2. For the given profile sharing factor k-space is segmented in several groups.

a group of profiles that are shared with previous dynamic scans,

a group of profiles that are shared with subsequent dynamic scans, and

one or more groups which are not shared with any further scans.

3. The profile order within the shared segments are determined by a stochastical or quasi-stochastical order.

4. The order in which k-space segments are acquired over successive dynamic scans is determined to be reversed or symmetrical.

In FIG. 1 graphically an acquisition trajectory in k-space is depicted, in which an example of the profile sharing technique can be explained as follows: a 2-dimensional dynamic scan with three dynamic areas has a normal scan time of about 18 seconds with 6 seconds scan time for each dynamic area. In order to reduce the time resolution of successive scans from 6 to 4 seconds a profile sharing factor of ⅔ would be necessary. K-space is then grouped in three equal segments A, B and C or C, D and E or E, F and G, respectively. As can be seen in the lower part of the diagram the first three segments A, B and C form a first dynamic scan, whereas segments A and B are not shared and C is shared with the second dynamic scan. In the second dynamic scan segments C and E are shared by the first and third scans and segment D is not shared. In the third dynamic scan segments F and G are not shared and segment E is shared with the second dynamic scan. As further can be seen K-space is sampled in the first scan from the top, in the second scan from the bottom and in the third scan from the top again. This is called reverse or symmetrical order, which guarantees that groups of profiles from previous and present dynamic scans and from present and subsequent dynamic scans can be shared. The stochastic profile order that is used within each of the shared segments reduces artifacts which arise from a continuous variation of the signal. The signal discontinuity at the edge of a k-space segment would typically cause ghosting artifacts. A stochastical or quasi-stochastical profile order smears the artifacts out over the sampled signals so that the artifacts disappear.

In the case of a three-dimensional dynamic scan, shared segments can be selected in different ways as e.g. can be seen in the three examples of FIGS. 2a, 2b and 2c. The segments which are shared with the previous dynamic scans are denoted with reference sign 21. The segments shared with the subsequent dynamic scans are denoted with reference sign 22. In the example of FIG. 2c the segments 21 and 22 are randomly mixed.

The not shared segments can also be measured by a stochastical or quasi-stochastical profile order. The not shared segments can further be subdivided in sub-segments dependent from the size of the shared segments.

The above mentioned profile sharing technique can also be applied in combination with other profile sharing techniques which are characterized by a repetitive acquisition of the same k-space data. Examples of such techniques are keyhole sampling and UNFOLD (cf. Madore B, Glover G H, Pelc N J. Unaliasing by Fourier encoding the overlaps using the temporal dimension (UNFOLD), applied to cardiac imaging and fMRI, Magn Reson Med 1999; 42: 813-828).

The above mentioned technique can also be combined with scanning only half of k-space. The outer k-space segment consist in that case of a mixture of data of previous and subsequent (randomly ordered) dynamic scans. Also parallel imaging techniques as SENSE or SMASH can be combined with this novel technique of profile sharing.

A practical embodiment of an MR device is shown in FIG. 3, which includes a first magnet system 2 for generating a steady magnetic field, and also means for generating additional magnetic fields having a gradient in the X, Y, Z directions, which means are known as gradient coils 3. The Z direction of the co-ordinate system shown corresponds to the direction of the steady magnetic field in the magnet system 2 by convention, which only should be linear. The measuring co-ordinate system x, y, z to be used can be chosen independently of the X, Y, Z system shown in FIG. 2. The gradient coils 3 are fed by a power supply unit 4. An RF transmitter coil 5 serves to generate RF magnetic fields and is connected to an RF transmitter and modulator 6. A receiver coil is used to receive the magnetic resonance signal generated by the RF field in the object 7 to be examined, for example a human or animal body. This coil 5 represents an array of multiple receiver antennae. Furthermore, the magnet system 2 encloses an examination space which is large enough to accommodate a part of the body 7 to be examined. The RF coil 5 is arranged around or on the part of the body 7 to be examined in this examination space. The RF transmitter coil 5 is connected to a signal amplifier and demodulation unit 10 via a transmission/reception circuit 9. The control unit 11 controls the RF transmitter and modulator 6 and the power supply unit 4 so as to generate special pulse sequences which contain RF pulses and gradients. The control unit 11 also controls detection of the MR signal(s), whose phase and amplitude obtained from the demodulation unit 10 are applied to a processing unit 12. The control unit 11 and the respective receiver coils 3 and 5 are equipped with control means to enable switching between their detection pathways on a sub-repetition time basis (i.e. typically less than 10 ms). These means comprise inter alia a current/voltage stabilisation unit to ensure reliable phase behaviour of the antennae, and one or more switches and analogue-to-digital converters in the signal path between coil and processing unit 12. The processing unit 12 processes the presented signal values so as to form an image by transformation. This image can be visualized, for example by means of a monitor 13.

1. A magnetic resonance imaging method for two-dimensional or three-dimensional imaging of an examination zone, in which k-space is segmented in several parts and is scanned at predetermined sampling positions, whereas magnetic resonance signals of a first data set over a first part of k-space and magnetic resonance signals of subsequent reduced data sets over further parts of k-space are acquired, and data of the subsequent reduced data sets are completed with data of the first data set in order to obtain a full image of the scanned object, wherein, for a given profile sharing factor, in a second part of k-space a group of profiles is shared with previous dynamic scans, in a third part of k-space a group of profiles is shared with subsequent dynamic scans and in the first part of k-space one or more groups of profiles are not shared in further scans.

2. A method as claimed in claim 1, wherein for a given sequence of dynamic scans, the time resolution of the scans is reduced within predetermined limits to a prescribed value by adapting the profile sharing factor.

3. A method as claimed in claim 1, wherein the shared profiles are determined by a stochastical of quasi-stochastical order.

4. A method as claimed in claim 1, wherein the profile order in which k-space parts are acquired by successive dynamic scans is reversed or symmetrical.

5. A method as claimed in claim 3, wherein the first part is subdivided in sub-segments dependent from the size of the shared parts.

6. A method as claimed in claim 3, wherein the profiles within the first part or sub-segments thereof are determined by a stochastical or quasi-stochastical order.

7. A magnetic resonance imaging apparatus for obtaining an MR image from a plurality of signals using a method as claimed in claim 1 comprising
means for excitation of spins in a part of the object,
at least one receiver antenna for sampling a plurality of signals,
means for segmenting k-space in several parts,
means for scanning k-space at predetermined sampling positions,
means for acquiring magnetic resonance signals of a first data set over a first part of k-space,
means for acquiring magnetic resonance signals of subsequent reduced data sets over further parts of k-space,
means for completing data of the subsequent reduced data sets with data of the first data set in order to obtain a full image of the scanned object, and
means for sharing a group of profiles with previous dynamic scans in a second part of k-space, for sharing a group of profiles with subsequent dynamic scans in a third part of k-space and for not sharing one or more groups of profiles in further scans in the first part of k-space, dependent from a given profile sharing factor.

8. A computer program product stored on a computer usable medium for forming an image by means of a magnetic resonance method, comprising a computer readable program means for causing the computer to control the execution of:
excitation of spins in a part of the object,
sampling a plurality of signals by at least one receiver antenna,
segmenting k-space in several parts,
scanning k-space at predetermined sampling positions,
acquiring magnetic resonance signals of a first data set over a first part of k-space,
acquiring magnetic resonance signals of subsequent reduced data sets over further parts of k-space,
completing data of the subsequent reduced data sets with data of the first data set in order to obtain a full image of the scanned object, and
sharing a group of profiles with previous dynamic scans in a second part of k-space, for sharing a group of profiles with subsequent dynamic scans in a third part of k-space and for not sharing one or more groups of profiles in further scans in the first part of k-space, dependent from a given profile sharing factor.
